(19) United States
(12) Patent Application Publication
(10) Pub. No.: US 2014/0324497 A1
(43) Pub. Date: Oct. 30, 2014

(54) TRACKING BUSINESS PROCESSES AND INSTANCES

(71) Applicants: Nitin Kumar Verma, Dehradun (IN); Harshavardhan Jegadeesan, Mannheim (DE)

(72) Inventors: Nitin Kumar Verma, Dehradun (IN); Harshavardhan Jegadeesan, Mannheim (DE)

(21) Appl. No.: 13/873,230

(22) Filed: Apr. 30, 2013

(51) Int. Cl. G06Q 10/06

(52) U.S. Cl. CPC G06Q 10/063114
USPC 705/7.15

(57) ABSTRACT

Various embodiments of systems and methods for tracking business processes and instances are described herein. In one aspect, the method includes identifying a log-in information of a user and based upon the log-in information, rendering at least one of one or more business processes associated with the user and a request tab for displaying one or more requests created by the user. A selection of one of a business process and the request tab is received. Based upon the selection, a GUI is rendered. The GUI comprises a database table associated with one of the selected business process and the request tab. The GUI also includes a graphical representation. The graphical representation comprises status indicators displaying respective statuses and a number of requests pending under respective statuses for the selected business process or the selected request tab.

### BACKGROUND

A Business process or instance comprises a sequence of tasks to produce a specific service or product. Information related to business processes or instances are maintained in a database table. The database table is analyzed to keep track of business processes or instances. Analyzing large volume of data in the database table might be inconvenient and a time consuming task. Also, retrieving relevant information from the database table is a cumbersome task. Therefore, tracking business processes and instances using the database table might be inefficient, inconvenient, and time consuming.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram of a system including an analyzer for tracking business processes and instances associated with a user, according to an embodiment.

FIG. 2 is a graphical user interface displaying a database table and a graphical representation of instances created by the user, according to an embodiment.

FIG. 3 illustrates the database table filtered based upon a selection in the graphical representation of FIG. 2, according to an embodiment.

FIG. 4 is a graphical user interface displaying a database table and a graphical representation of a business process under an overview, according to an embodiment.

FIG. 5 illustrates the database table filtered based upon a selection in the graphical representation of FIG. 4, according to an embodiment.

FIG. 6 illustrates the database table filtered based upon another selection in the graphical representation of FIG. 4, according to an embodiment.

FIG. 7 is a graphical user interface displaying a database table and a graphical representation of the business process under a phase view, according to an embodiment.

FIG. 8 illustrates the database table filtered based upon a selection in the graphical representation of FIG. 7, according to an embodiment.

FIG. 9 is a graphical user interface displaying a graphical representation of the business process including an indicator for navigating to next screen, according to an embodiment.

FIG. 10 is a graphical user interface displaying a graphical representation of the business process under a performance view, according to an embodiment.

FIG. 11 is a graphical user interface displaying a database table and a graphical representation of an instance, according to an embodiment.

FIG. 12 is a flow chart for rendering a graphical user interface to track business processes and instances associated with a user, according to an embodiment.

FIG. 13 is a flow chart for representing a business process under various categories, according to an embodiment.

FIG. 14 is a block diagram of an exemplary computer system, according to an embodiment.

### DETAILED DESCRIPTION

Embodiments of techniques for tracking business processes and instances are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

A business process comprises a sequence of phases to produce a service or product. Business process may be visualized as a workflow with interleaving decision points. For example, an ‘article creation,’ may be a business process for procuring any article or product. Using the ‘article creation’ a user, e.g., a store manager, can procure a product. In one embodiment, the business process is termed as business scenario. An instance or request is an occurrence of the business process. The instance of the business process is created for producing the specific service or the product. For example, an instance of the business process ‘article creation’ is created by the store manager for procuring a product.

The business process comprises a plurality of phases. For example, the business process ‘article creation’ may comprise the phases such as article request, procure, good receipt, dispatch, and point of sale (POS). The phases are to be executed in a sequence to produce a required service or product. Respective phases of the business process comprise one or more steps. For example, the phase ‘article request’ comprises steps ‘request created’ and ‘entry into an enterprise resource planning (ERP) system.’

Critical information is that information of the business process or instance which can be of more interest to a user or otherwise emphasized. What is critical may vary depending on the context. In one context, the information which is more frequently analyzed in the business process or instance may be critical. In some embodiments, the critical information are predefined at design-time, e.g., during a design or development of the business process. For example, statuses of the business process, phases associated with the business process, target time for executing the business process, etc., may be specified as the critical information.

A target cycle time is a time required to complete one cycle of operation. The target cycle time may also be defined as the time required for completing a function or a task from start to finish. For example, a target cycle time of the business process is the time required to complete the business process from start to finish, i.e., from a first phase to a last phase. In one embodiment, the target cycle time of the business process is predefined at designed time. The execution of individual instances or requests of the business process is required to be completed by the target cycle time.

Current cycle time of the business process is an average cycle time taken to complete the execution of the business process. The current cycle time is calculated based upon execution of various requests under the business process. For example, suppose the predefined target cycle time of the business process is 8 hours and request1, request2, and request3 of the business process are executed in 4 hours, 6 hours, and 8 hours, respectively, then the average cycle time is ((4+6+8)/3) hours which is 6 hours. Therefore, the average cycle time is less the target cycle time and the business process is executing on track.

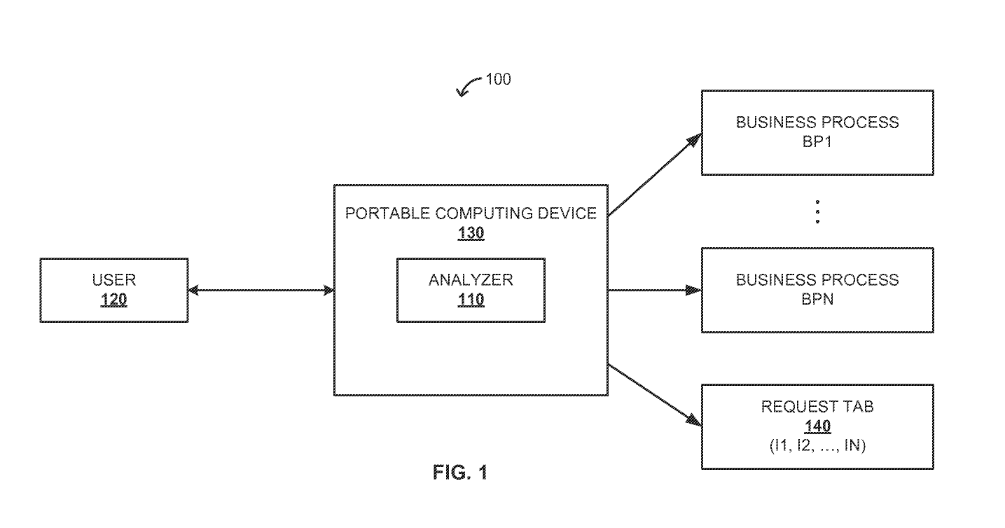

FIG. 1 illustrates one embodiment of a system 100 including an analyzer 110 for tracking business processes BP1-BPN and instances I1-IN associated with a user 120. The analyzer 110 may be an application installed on a portable computing device 130. The user 120 logs in the analyzer 110. The analyzer 110 identifies the log-in information of the user 120. Based upon the identified log-in information, the analyzer 110 displays the business processes BP1-BPN associated with the user 120. In one embodiment, the analyzer 110 also renders a request tab 140 for displaying requests or instances I1-IN created by the user 120. The user 120 can select one of the business processes BP1-BPN or the request tab 140. Based upon the selected business process or the selected request tab 140, the analyzer 110 displays a graphical representation (not shown). The graphical representation comprises critical information related to the business process or the request tab 140 selected by the user 120.

The user 120 may be any business user such as a store manager, a business process operator, a business process analyst, etc. In one embodiment, the user 120 is a ‘requestor’ who creates a request for performing a specific task. For example, the store manager is the requestor who creates the request for procuring a product for the store. In one embodiment, the user 120 is a ‘business process operator’ or an ‘operator’ who operates on the requests created by other users. In one embodiment, operating on the requests includes tracking or analyzing the requests. In one embodiment, operating on the requests includes performing a task related to the request. In one embodiment, the user 120 performs multiple roles at a time. For example, the user 120 can be the requestor as well as the operator. The user 120 can logs in the analyzer 110 installed on the portable computing device 130 to view the requests created by the user 120 or to operate on the requests created by the other users.

The portable computing device 130 may be any computing device which can be carried by the user, e.g., a laptop, a mobile phone, a smartphone, a tablet computer, etc. The portable computing device 130 is communicatively coupled to the analyzer 110. Once the user 120 logs in the analyzer 110, the analyzer 110 identifies the log-in information of the user 120. Based upon the log-in information, the analyzer 110 determines whether the user 120 is the requestor, the operator, or both.

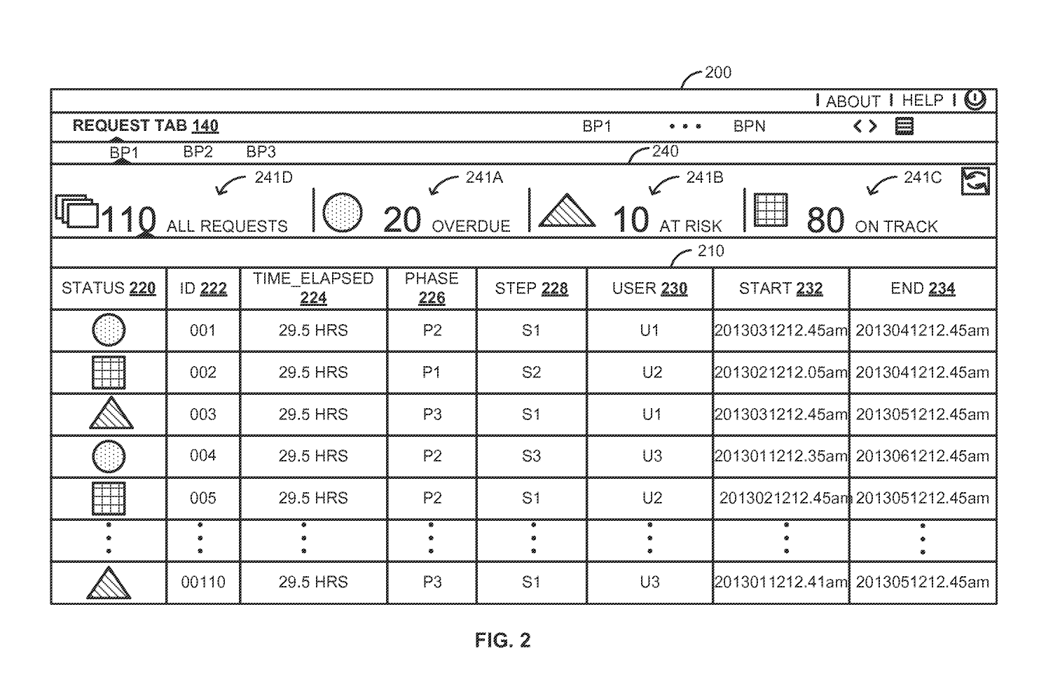

When the user 120 is the operator, the analyzer 110 displays the business processes BP1-BPN. The business processes BP1-BPN include the requests to be operated by the user 120. When the user 120 is the requestor, the analyzer 110 displays the request tab 140. The request tab 140 includes the requests (e.g., I1-IN) created by the user 120. When the user 120 is the requestor as well as the operator, the analyzer 110 displays the business processes BP1-BPN as well as the request tab 140. FIG. 2 illustrates a graphical user interface (GUI) 200 including the business process BP1-BPN and the request tab 140.

When the request tab 140 is selected, the analyzer 110 displays the business processes BP1, BP2, and BP3, underneath the request tab 140. The business processes BP1, BP2, and BP3 are business processes under which the user 120 has created the requests. Alternately, the business processes BP1, BP2, and BP3 shows that the user 120 has created requests pertaining to the business processes BP1, BP2, and BP3. The user 120 can select any one of the business processes BP1, BP2, and BP3 to view the requests pending under the respective business processes. In one embodiment, by default a first business process BP1 is automatically selected. The information related to the selected business process, e.g., BP1, is displayed on the GUI 200.

The GUI 200 includes a database table 210 related to the selected business process BP1. The database table 210 displays the requests created under the business process BP1. The database table 210 includes data fields namely STATUS 220, ID 222, TIME_ELAPSED 224, PHASE 226, STEP 228, USER 230, START 232, and END 234. The data field ‘STATUS’ 220 indicates statuses of the respective requests created under the business process BP1. In one embodiment, the status may be one of ‘overdue,’ ‘on track,’ and ‘at risk.’ ‘Overdue’ indicates that a request has exceeded a target time of completion, ‘on track’ indicates that the request is executing on track and expected to be completed within the target time of completion, and ‘at risk’ indicates that the request requires attention to be completed within the target time. In one embodiment, the ‘STATUS’ 220 is represented by different symbols and/or colors to indicate different status. For example, ‘on track’ may be represented by a green color rectangle (shown as meshed rectangle), ‘overdue’ may be represented by a red color circle (shown as dotted circle), and ‘at risk’ may be represented by a yellow color triangle (shown as hashed triangle).

The data field ‘ID’ 222 indicates a unique ID assigned to the respective requests. In one embodiment, the ‘ID’ 222 is automatically assigned to the respective requests by the analyzer 110. For example, the ID ‘001’ is assigned to a first request and ID ‘00110’ is assigned to a last request of the database table 210. In one embodiment, the ID 230 may have a numerical value or an alpha numeric value. The data field ‘TIME_ELAPSED’ 224 indicates the time elapsed since the request is created. The requests require to go through phases included within the business process. For example, the request (ID: 001) may require to go through the phases, e.g., P1, P2, and P3 included within the business process BP1. The data field ‘PHASE’ 226 indicates a current phase in which the respective request is executing. For example, the request ‘001’ is executing in phase P2. A phase comprises one or more steps. For example, the phase P2 may comprise steps S1 and S2. The data field ‘STEP’ 228 indicates the step in which the request is executing. For example, the request ‘001’ is executing in step S1 of phase P2. The data field ‘USER’ 230 indicates a name of a user who is responsible for the respective requests. For example, the user U1 is responsible for the request 001. The data field ‘START’ 232 indicates a date and time when the request is created. For example, the request 001 is created on 12, Mar. 2013 at 12:45 am. The data field ‘END’ 234 indicates a target date and time by which the request is expected to be completed. For example, the request 001 is expected to be completed by 12, Apr. 2013 at 12:45 am.

In one embodiment, the data fields 220-234 are updated in real-time. Updating in real-time implies updating as soon as the changes are incorporated. In one embodiment, some data fields of the database table 210 are critical. In one embodiment, the critical data fields are more frequently analyzed data fields. In one embodiment, the critical data fields may be predefined at design-time. For example, the data field ‘STATUS’ 220 may be defined as the critical data field at design-time.

The GUI 200 also includes a graphical representation 240. In one embodiment, the critical data fields, e.g., ‘STATUS’ 220 are identified by the analyzer 110. Based upon the identified critical data fields, the analyzer 110 renders the graphical representation 240. The graphical representation 240 comprises status indicators 241A, 241B, and 241C. The status indicators 241A, 241B, and 241C indicate statuses related to the requests. For example, the status indicator 241A indicates the status ‘overdue,’ the status indicator 241B indicates the status ‘at risk,’ and the status indicator 241C indicates the status ‘on track.’ The status indicators 241A, 241B, and 241C comprise a suitable symbol and/or color to indicate respective statuses. For example, the status indicator 241A comprises a red color circle (shown as dotted circle) to indicate ‘overdue,’ the status indicator 241B comprises a yellow color triangle (shown as hashed triangle) to indicate ‘at risk,’ and the status indicator 241C comprises a green color rectangle (shown as meshed rectangle) to indicate ‘on track.’

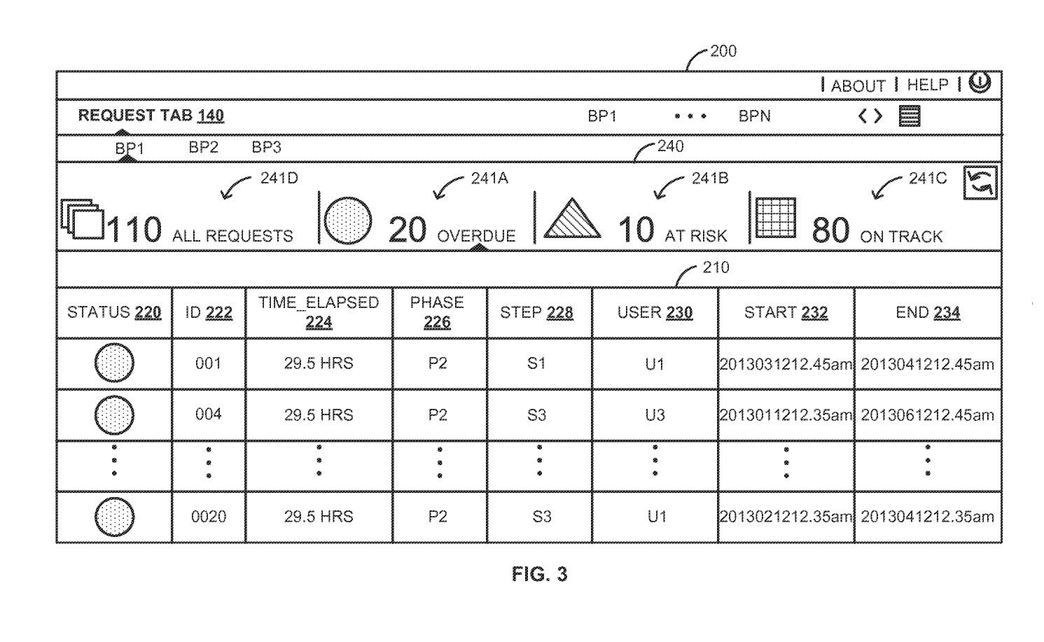

In one embodiment, number of requests pending under respective statues is also displayed. For example, ‘20’ is displayed in the status indicator 24 IA to indicate that twenty requests are ‘overdue’ and ‘80’ is displayed in the status indicator 241C to indicate that eighty requests are ‘on track.’ The status indicators 241A, 241B, and 241C are selectable and the number of requests pending under respective statues is updated in real-time. The database table 210 is filtered based upon a selection of the status indicators 241A, 241B, and 241C. For example, when the user 120 selects the status indicator 241A, the database table 210 is filtered to display the requests under ‘overdue,’ as illustrated in FIG. 3.

In one embodiment, the graphical representation 240 also includes an indicator 241D. The indicator 241D may be termed as ‘ALL REQUESTS’ and is selectable. When the indicator 241D is selected, the database table 210 is updated to display all the requests created by the user 120 under the business process BP1. In one embodiment, the total number of requests pending under the business process BP1 is displayed in the indicator 241D. For example, ‘110’ is displayed in the indicator 241D to indicate that 110 requests are pending under the business process BP1. When the user 120 selects the indicator 241D, the database table 210 displays all requests created by the user 120 under the business process BP1.

When any other business process displayed below the request tab 140, e.g., BP2 or BP3 is selected, corresponding database table and graphical representation similar to the database table 210 and the graphical representation 240, respectively, are displayed.

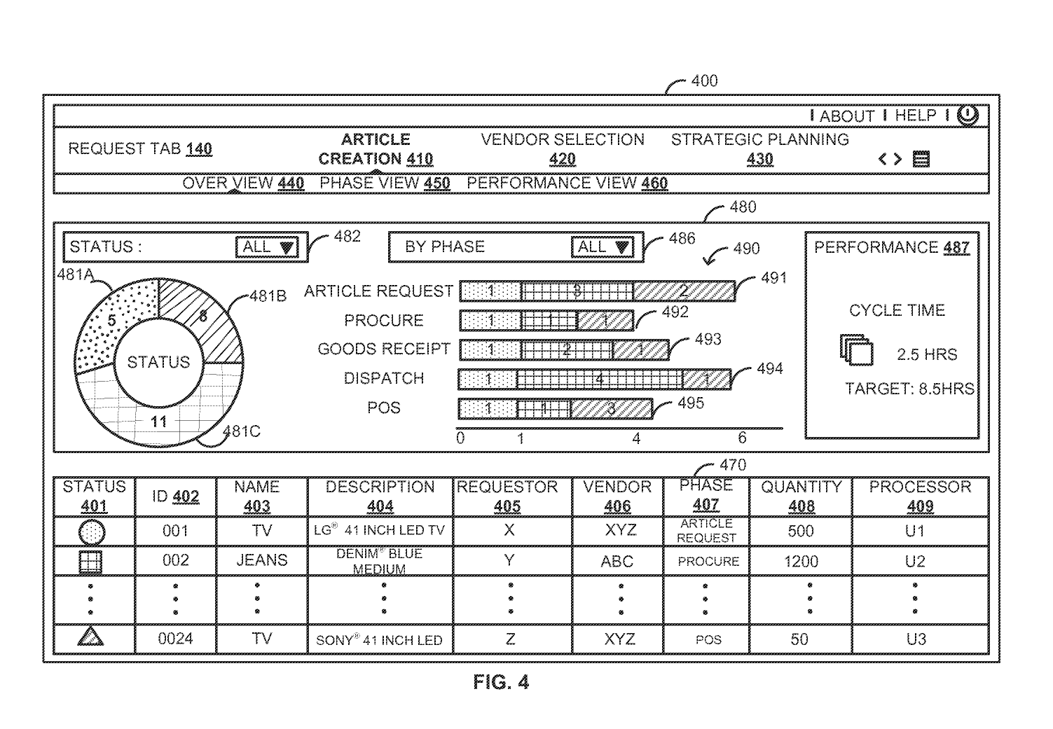

In one embodiment, the user 120 can select one of the business processes BP1-BPN that includes the requests created by other users. FIG. 4 shows ‘ARTICLE CREATION’ 410, ‘VENDOR SELECTION’ 420, and ‘STRATEGIC PLANNING’ 430 as an example of the business processes that includes the requests created by other users. The user 120 can select one of the business processes, e.g., ‘ARTICLE CREATION’ 410 to operate on the requests pending under ‘ARTICLE CREATION’ 410. In one embodiment, the first business process ‘ARTICLE CREATION’ 410 is automatically selected by default. Once the business process ‘ARTICLE CREATION’ 410 is selected, the analyzer 110 displays one or more views or categories under which the selected business process ‘ARTICLE CREATION’ 410 is representable. The one or more categories are displayed below the business process ‘ARTICLE CREATION’ 410. In one embodiment, the categories may be ‘OVERVIEW’ 440, ‘PHASE VIEW’ 450, and ‘PERFORMANCE VIEW’ 460. The selected business process ‘ARTICLE CREATION’ 410 may be viewed under any of the categories.

In one embodiment, when the user 120 selects the ‘OVERVIEW’ 440, the analyzer 110 displays a GUI 400 including a database table 470. In one embodiment, the first category ‘OVERVIEW’ 440 is selected by default and the GUI 400 is automatically displayed. The database table 470 includes information of the requests pending under the business process ‘ARTICLE CREATION’ 410. The database table 470 includes data fields namely STATUS 401, ID 402, NAME 403, DESCRIPTION 404, REQUESTOR 405, VENDOR 406, PHASE 407, QUANTITY 408, and PROCESSOR 409. The data field ‘STATUS’ 401 indicates current status of the respective requests pending under ‘ARTICLE CREATION’ 410. As discussed, the status may be one of ‘overdue,’ ‘on track,’ and ‘at risk.’ The data field ‘ID’ 402 indicates the unique ID assigned to the respective requests. The data field ‘NAME’ 403 indicates a name of the requested article or item. The data field ‘DESCRIPTION’ 404 provides details or description of the respective requests. For example, the ‘DESCRIPTION’ 404 provides description of the requested article, e.g., LG® 41′ LED TV. The data field ‘REQUESTOR’ 405 indicates a name of a person created the respective requests. The data field ‘VENDOR’ 406 indicates a name of a vendor delivering the requested article. The data field ‘PHASE’ 407 indicates a phase in which the respective requests are executing. The data field ‘QUANTITY’ 408 indicates a number or quantity of the requested articles. The data field ‘PROCESSOR’ 409 indicates a name of a person responsible for the end to end execution of the respective requests. The data fields 401-409 of the database table 470 are updated in real-time.

In one embodiment, the GUI 400 also includes a graphical representation 480. The graphical representation 480 includes status indicators 481A, 481B, and 481C. The status indicators 481A, 481B, and 481C indicate respective statuses. For example, the status indicator 481A indicates the status ‘overdue,’ the status indicator 481B indicates the status ‘at risk,’ and the status indicator 481C indicates the status ‘on track’ In one embodiment, the status indicators 481A, 481B, and 481C are displayed in different color. For example, the status indicator 481A is displayed in red color (shown as dotted section) to indicate the status ‘overdue.’ the status indicator 481B is displayed in yellow color (shown as hashed section) to indicate the status ‘at risk,’ and the status indicator 481C is displayed in green color (shown as meshed section) to indicate the status ‘on track.’ The status indicators 481A, 481B, and 481C also display a number of requests pending under respective status. For example, the status indicator 481C displays ‘11’ to indicate that eleven requests are ‘on track.’ A size of the status indicators 481A, 481B, and 481C are directly proportional to the number of requests pending under the respective status. The status indicators 481A, 481B, and 481C are selectable and updated in real-time. In one embodiment, the selected status indicator is highlighted, e.g., by making the status indicator brighter.

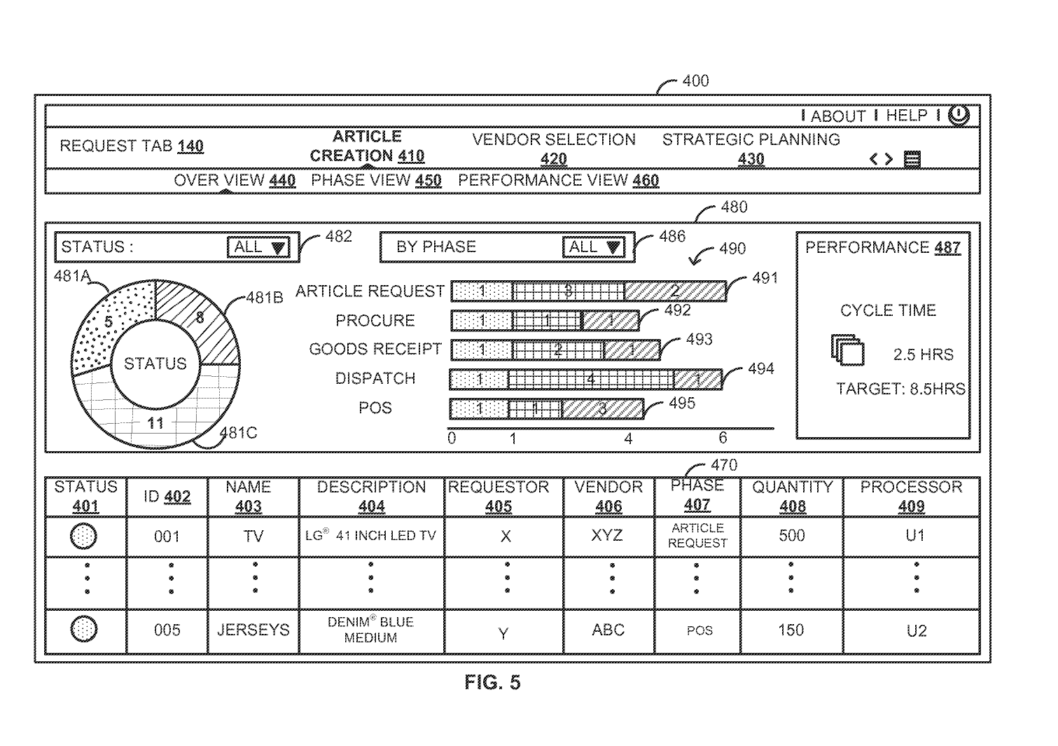

In one embodiment, the database table 470 is filtered based upon a selection of the status indicator. For example, when the status indicator 481A is selected, the database table 470 is filtered to display the requests pending under the status ‘overdue,’ as illustrated in FIG. 5. In one embodiment, the graphical representation 480 may also include a filter 482 to filter the database table 470 by status.

Referring to FIG. 4, in one embodiment, the graphical representation 480 includes a graph 490. The graph 490 shows various phases of the business process ‘ARTICLE CREATION’ 410. For example, the graph 490 shows the phases ‘ARTICLE REQUEST,’ ‘PROCURE,’ ‘GOOD RECEIPT,’ ‘DISPATCH,’ and ‘point of sale (POS)’ associated with the ‘ARTICLE CREATION’ 410. In one embodiment, the phases are displayed as bars. For example, the phases ‘ARTICLE REQUEST,’ ‘PROCURE,’ ‘GOOD RECEIPT,’ ‘DISPATCH,’ and ‘POS’ are represented by bars 491-495, respectively. A size of a bar is directly proportional to number of requests pending in their respective phase. For example, the smallest bar 492 representing the phase ‘PROCURE’ indicates that the least number of requests is pending in the ‘PROCURE’ phase. The bars 491-495 are updated in real-time.

In one embodiment, the bars 491-495 include phase status indicators to indicate various statuses of requests pending under respective phase. For example, the bar 491 includes a red color section (shown as dotted section) to represent requests under ‘overdue,’ a green color section (shown as meshed section) to represent requests under ‘on track.’ and a yellow color section (shown as hashed section) to represent requests ‘at risk.’ In one embodiment, the status indicator displays number of request pending under respective statues. For example, the red color section (shown as dotted section) of the bar 491 displays ‘1’ to indicate that one request is ‘overdue’ in ‘ARTICLE REQUEST’ phase.

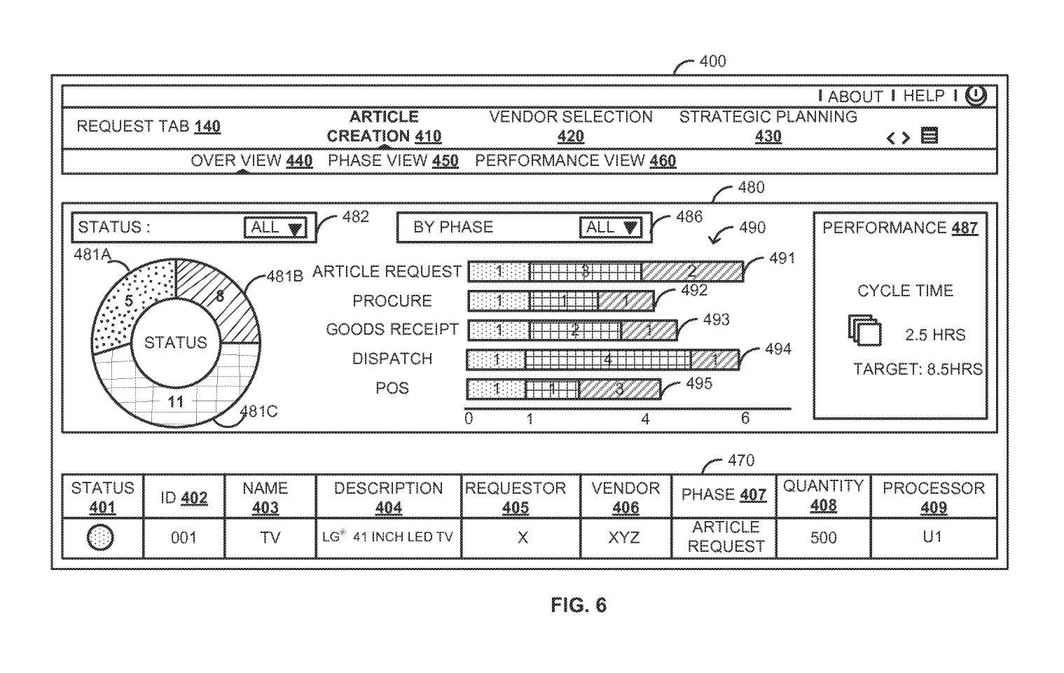

In one embodiment, the database table 470 is filtered based upon a selection in the graph 490. For example, when the dotted section of the bar 491 is selected, the database table 470 is filtered to display the requests pending under the phase ‘ARTICLE REQUEST’ and whose status is ‘overdue,’ as illustrated in FIG. 6. In one embodiment, the graphical representation 480 also includes a filter 486 to filter the database table 470 by phases.

Referring back to FIG. 4, in one embodiment, the graphical representation 480 also displays performance information 487 of the business process ‘ARTICLE CREATION’ 410. In one embodiment, the performance information 487 comprises a predefined target cycle time for completing the business process ‘ARTICLE CREATION’ 410 and a currently executing cycle time for the business process ‘ARTICLE CREATION’ 410. For example, as shown the target cycle time is 8.5 hours while the current cycle time is 2.5 hours. Based upon the performance information 487, the user 120 can analyze whether the business process ‘ARTICLE CREATION’ 410 is processing ‘on track.’

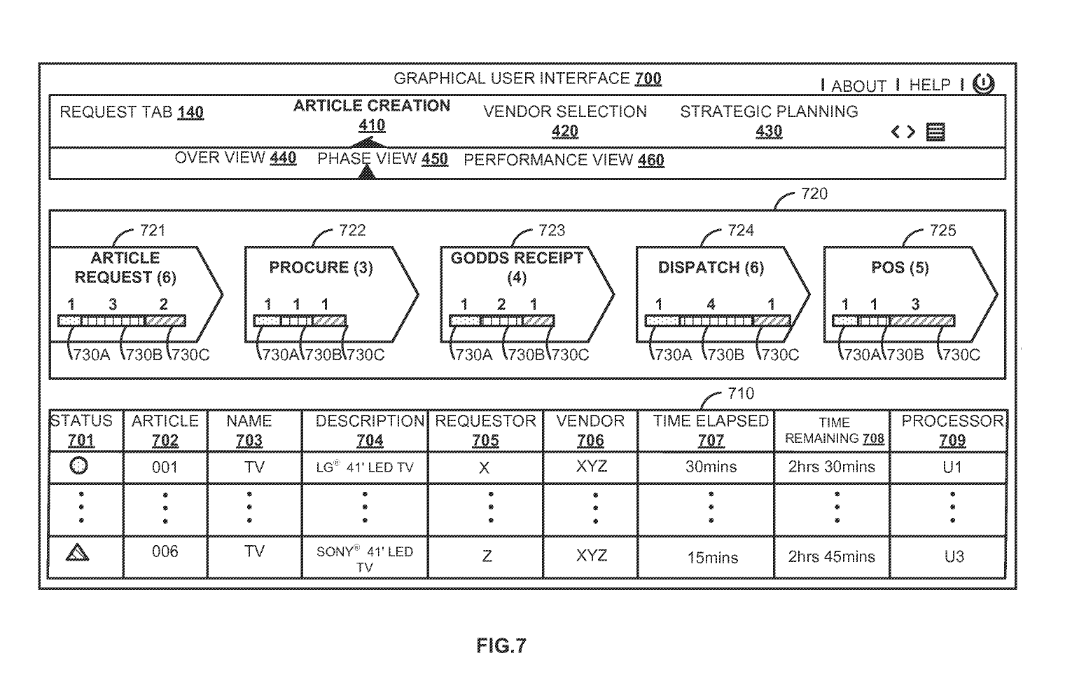

Referring to FIG. 7, when the ‘PHASE VIEW’ 450 is selected, the analyzer 110 displays a GUI 700. The GUI 700 includes a database table 710 related to the business process ‘ARTICLE CREATION’ 410. The database table 710 includes data fields namely STATUS 701, ARTICLE 702, NAME 703, DESCRIPTION 704, REQUESTOR 705, VENDOR 706, TIME ELAPSED 707, TIME REMAINING 708, and PROCESSOR 709. The data field ‘STATUS’ 701 indicates status of the respective requests pending under the business process ‘ARTICLE CREATION’ 410. As discussed, the status may be one of ‘overdue,’ ‘on track,’ and ‘at risk.’ The data field ‘ARTICLE’ 702 indicates a unique ID assigned to the respective requests. The data field ‘NAME’ 703 indicates the name of requested articles. As discussed in above paragraphs, the data field ‘DESCRIPTION’ 704 provides description of the request. The data field ‘REQUESTOR’ 705 indicates a name of a person created the respective requests. The data field ‘VENDOR’ 706 indicates a name of a vendor delivering the respective requested articles. The data field ‘TIME ELAPSED’ 707 indicates the time elapsed since the respective requests are created. The data field ‘TIME REMAINING’ 708 indicates a time remaining for completing the respective requests within their respective target time. The data field ‘PROCESSOR’ 709 indicates a person responsible for the request. The data fields 701-709 of the database table 710 are updated in real-time.

The GUI 700 also includes a graphical representation 720. The graphical representation 720 displays the phases ‘ARTICLE REQUEST,’ ‘PROCURE,’ ‘GOOD RECEIPT,’ ‘DISPATCH,’ and ‘POS’ associated with the business process ‘ARTICLE CREATION’ 410. The phases ‘ARTICLE REQUEST,’ ‘PROCURE,’ ‘GOOD RECEIPT,’ ‘DISPATCH,’ and ‘POS’ are displayed as interactive graphical elements 721-725, respectively. In one embodiment, the database table 710 is filtered based upon a selection in the interactive graphical elements 721-725. For example, when the interactive graphical element 721 is selected, the database table 710 is filtered to display the requests pending under the phase ‘ARTICLE REQUEST.’ In one embodiment, by default, the first interactive graphical element 721 is automatically selected and the database table 710 displays the requests pending under the phase ‘ARTICLE REQUEST.’

In one embodiment, the interactive graphical elements 721-725 include phase status indicators 730A-730C. The status indicators 730A-730C is represented in different color to indicate different status. For example, the status indicator 730A is represented in red color (shown as dotted section) to indicate the status ‘overdue,’ the status indicator 730B is represented in green color (shown as meshed section) to indicate the status ‘on track,’ and the status indicator 730C is represented in yellow color (shown as hashed section) to indicate the status ‘at risk.’ In one embodiment, the status indicators 730A-730C display number of requests pending under respective statuses for the respective phases. For example, the status indicator 730A of the interactive graphical element 721 displays ‘1’ to indicate that one request is ‘overdue’ under the phase ‘ARTICLE REQUEST.’

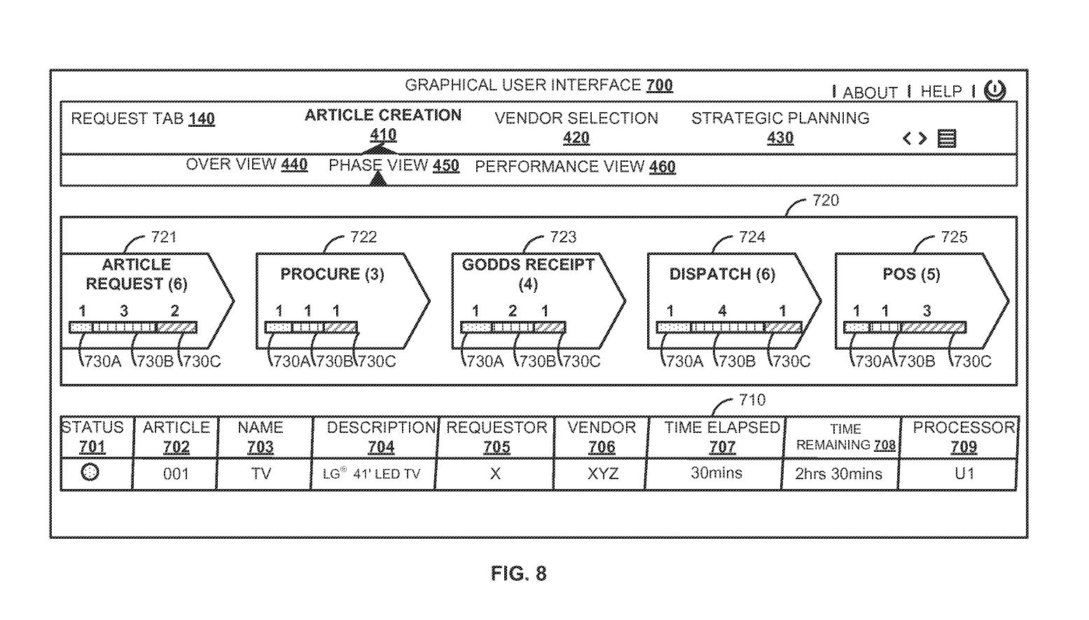

The status indicators 730A, 730B, and 730C are updated in real-time. A size of the status indicators 730A, 730B, and 730C is directly proportional to the number of requests pending under respective status. Therefore, the size of the status indicators 730A, 730B, and 730C keeps varying in real-time. The status indicators 730A, 730B, and 730C are selectable. In one embodiment, the database table 710 is filtered based upon selected status indicator 730A-730C. Referring to FIG. 8, when the status indicator 730A (indicating status: overdue) of the interactive graphical element 721 (indicating phase: ARTICLE REQUEST) is selected, the database table 710 is filtered to display the requests pending under the phase ‘ARTICLE REQUEST’ whose status is ‘overdue.’

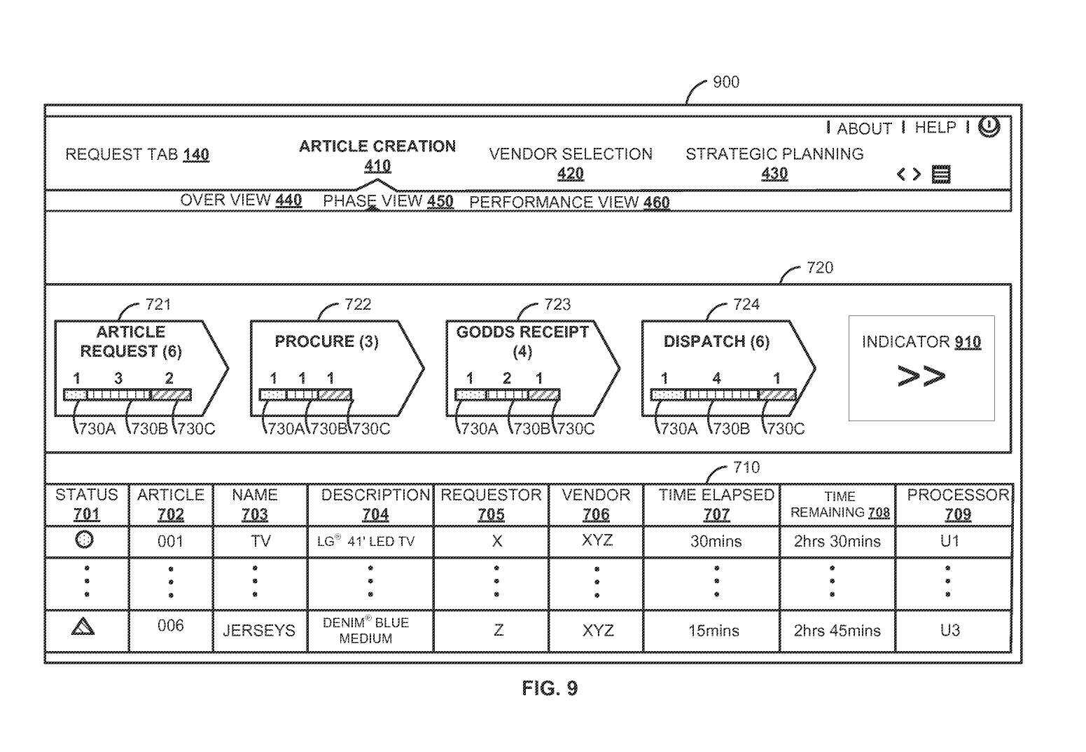

In one embodiment, when the user 120 hovers a cursor over the interactive graphical element, e.g., 721, a pop-up (not shown) is rendered to display information related to the phase of the interactive graphical element 721. The information related to the phase may be a name of the phase represented by the interactive graphical element 721, total number of requests pending under the phase, a name of a person responsible for the phase, a predefined target time for completing the execution of the phase and current cycle time, etc. Referring to FIG. 9, when all the interactive graphical elements could not be displayed on a single screen 900, the screen 900 includes an indicator 910 to indicate that the remaining interactive graphical elements or phases can be viewed on a next screen. For example, the screen 900 displays the phases ‘ARTICLE REQUEST,’ ‘PROCURE,’ ‘GOOD RECEIPT,’ and ‘DISPATCH,’ and the last phase ‘POS’ can be viewed on the next screen using the indicator 910.

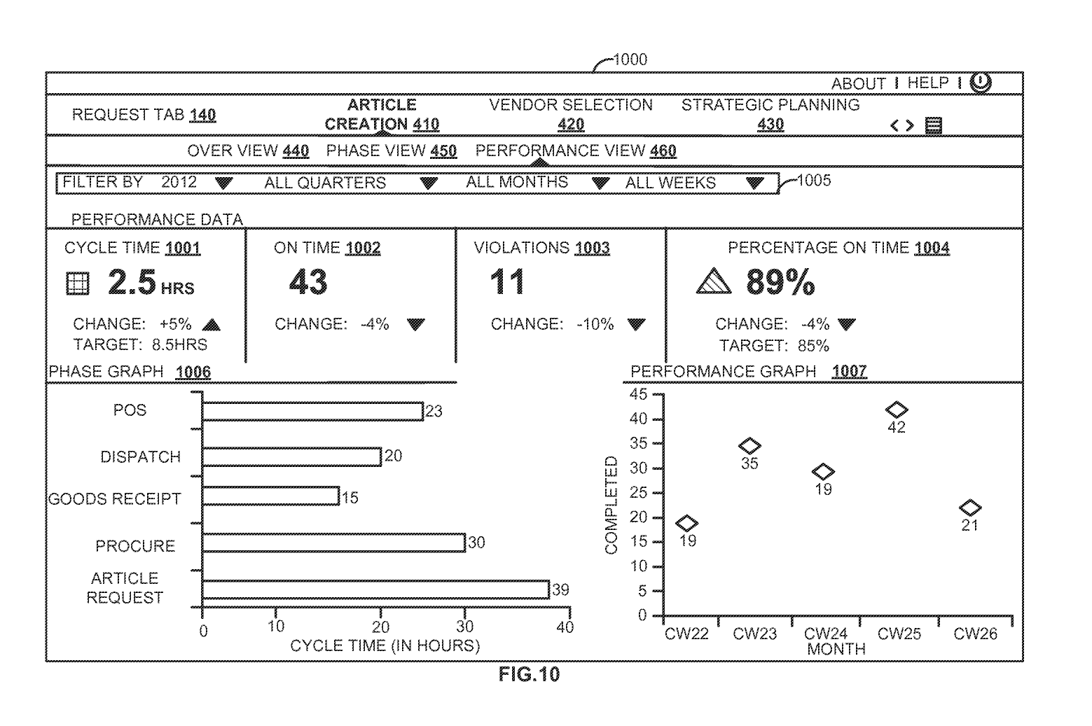

Referring to FIG. 10, when the ‘PERFORMANCE VIEW’ 460 is selected, the analyzer 110 renders a graphical representation 1000. The graphical representation 1000 comprises performance data, e.g., ‘CYCLE TIME’ 1001, ‘ON TIME’ 1002, ‘VIOLATIONS’ 1003, and ‘PERCENTAGE ON TIME’ 1004. The ‘CYCLE TIME’ 1001 indicates a current average cycle time of the business process. For example, the current cycle time is 2.5 hours. In one embodiment, a status indicator is affixed to the cycle time to indicate whether the cycle time is on track, at risk, or overdue. For example, a green rectangle (shown as meshed rectangle) is prefixed to the cycle time to indicate that the cycle time is on track. In one embodiment, the target cycle time is also shown below the current cycle time and the user 120 can easily compare the target and the current cycle time.

The performance data ‘ON TIME’ 1002 indicates a number of requests completed on time or within the target time. For example, as shown ‘43’ requests are completed on time. The ‘VIOLATIONS’ 1003 indicates number of requests not completed within target time or which are completed with violation of the predefined target time. For example, as shown, ‘11’ requests are completed with violation. The performance data ‘PERCENTAGE ON TIME’ 1004 indicates a percentage of requests that are completed on time or completed within the target time. In one embodiment, there may be other performance data, e.g., ‘SHIPPING DURATION’ to indicate ‘a number of days or hours’ taken for shipping the product, etc. The graphical representation 1000 also includes a filter 1005 to filter performance data based upon at least one of year, quarters, months, and weeks.

In one embodiment, the performance data 1001-1004 includes a ‘change’ value. The ‘change’ value indicates a difference between the current value of the performance data and its previous value. For example, suppose the user 120 filters the performance data 1001-1004 for February 2013 then the ‘change’ value displayed under respective performance data 1001-1004 indicates the difference between the current value of the performance data and the previous value of respective performance data, i.e., value of performance data of January 2013. The ‘change’ may be positive or negative. For some performance data such as ‘CYCLE TIME’ 1001 and ‘VIOLATIONS’ 1003, the ‘change’ is positive when the value of the performance data decreases, while for some performance data such as ‘ON TIME’ 1002 and ‘PERCENTAGE ON TIME’ 1004 the change is positive when the value of the performance data increases. In one embodiment, a positive change is represented by a green color indicator and a negative change is represented by a red color indicator.

In one embodiment, the graphical representation 1000 includes a phase graph 1006 to display various phases of the business process ‘ARTICLE CREATION’ 410 against a cycle time. The phase graph 1006 displays an average cycle time of execution of respective phases. For example, as shown, the average cycle time for completing the execution of the phase ‘POS’ is 23. In one embodiment, a target cycle time of respective phases of the business process may be predefined. The user 120 can compare the average cycle time of respective phases with their respective target cycle time and can analyze which phase took more time to get executed. In one embodiment, the graphical representation 1000 also includes a performance graph 1007. The performance graph 1007 displays number of requests completed against calendar week. For example, as shown, ‘19’ requests are completed in the calendar week (CW) 22. The user 120 can view the number of requests completed in a particular calendar week. In one embodiment, the performance data 1001-1004 and the graphs 1006-1007 are updated in real-time.

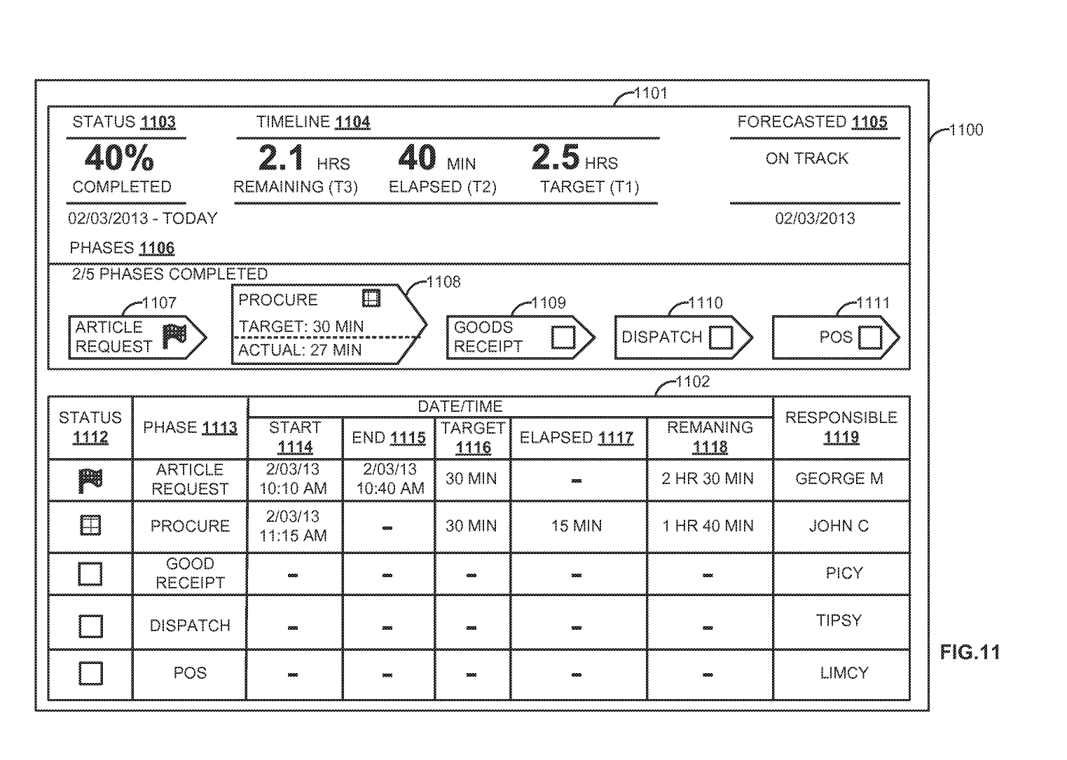

Referring back to FIG. 4, in one embodiment, when a request is selected from the database table, a graphical representation related to the selected request is displayed. In one embodiment, the request is selected by clicking a row corresponding to the request in the database table. For example, a request (ID: 002) may be selected by clicking the second row of the database table 470. FIG. 11 illustrates a GUI 1100 displayed upon selecting a request (ID: 002) from the database table 470. The GUI 1100 comprises a graphical representation 1101 and a database table 1102 related to the selected request. In one embodiment, the graphical representation 1101 includes status information 1103, timeline information 1104, and forecasted information 1105 of the selected request. The status information 1103 displays a percentage of execution completed, e.g., 40% indicates that 40% of the execution of the request is completed and 60% is remaining. In one embodiment, a date is displayed below the percentage execution completed. For example, the date Feb. 3, 2013 displayed below 40% indicates that the 40% execution of the request is completed as on Feb. 3, 2013. In one embodiment, a green color, a yellow color, or a red color symbol is affixed to the status information 1103 to indicate whether the status of the request is ‘on track,’ ‘at risk,’ or ‘overdue,’ respectively.

The timeline information 1104 displays a predefined target time T1 for completing the request, a time elapsed T2 indicating the time elapsed since the request is created, and a time remaining T3 indicating the time remaining for completing the request within the target time T1. The forecasted information 1105 displays a date by which the request is expected to be completed. The forecasted information 1105 also displays whether the request is expected to be completed ‘on time’ or would be ‘overdue.’ In one embodiment, a green color or red color symbol is affixed to the forecasted information 1105 to indicate whether the request is expected to be completed ‘on time,’ or ‘overdue,’ respectively.

In one embodiment, the graphical representation 1101 includes phase information 1106. The phase information 1106 displays various phases associated with the request. In one embodiment, the phases are displayed as interactive graphical elements. For example, the phases ‘ARTICLE REQUEST,’ ‘PROCURE,’ ‘GOOD RECEIPT,’ ‘DISPATCH,’ and ‘POS’ are displayed as interactive graphical element 1107-1111, respectively. The interactive graphical elements 1107-1111 include an execution indicator to indicate execution status of respective phases. For example, the execution indicator ‘a flag’ indicates that the phase is executed or completed on time, ‘a flag with circled end’ indicates that the phase is not executed on time, ‘a green rectangle’ indicates that the phase is currently executing on track, ‘a yellow triangle’ indicates that the phase is currently executing at risk, ‘a red circle’ indicates that the phase is currently executing as overdue, and ‘a blank rectangle’ indicates that the phase execution is not yet started. In one embodiment, the interactive graphical element of the currently executing phase is highlighted. For example, the interactive graphical element 1108 of the currently executing phase ‘PROCURE’ becomes larger in size than other interactive graphical elements. In one embodiment, the target cycle time and actual cycle time of the currently executing phase is displayed within its interactive graphical element.

The database table 1102 includes information related to various phases of the request. The database table 1102 includes the data fields namely STATUS 1112, PHASE 1113, START 1114, END 1115, TARGET 1116, ELAPSED 1117, REMAINING 1118, and RESPONSIBLE 1119. The data field ‘STATUS’ 1112 indicates execution status of respective phases associated with the request. The execution status may be one of ‘completed on time,’ ‘completed with violation,’ ‘not yet started,’ and ‘currently executing.’ In one embodiment, the ‘STATUS’ 1112 includes different symbols to indicate different execution status. For example, the flag indicates the execution status ‘completed on time,’ the flag with circled end indicates ‘completed with violation,’ the meshed rectangle indicates the status ‘currently executing on track,’ and the blank rectangle indicates ‘not yet started.’ The data field ‘PHASE’ 1113 indicates name of respective phases. The data field ‘START’ 1114 indicates the date and time when the execution of respective phases started. The data field ‘END’ 1115 indicates the date and time when the execution of respective phases ended. In one embodiment, for the phases not started yet, the ‘START’ 1114 and the ‘END’ 1115 field is blank. In one embodiment, the data field ‘END’ 1115 of currently executing phase is blank as the phase is not yet ended. The ‘TARGET’ 1116 indicates the predefined time for completing the execution of the respective phases. The ‘ELAPSED’ 1117 indicates the time elapsed since the execution of the respective phases started. The ‘REMAINING’ 1118 indicates the time remaining for completing the execution of the request within the target time. The data field ‘RESPONSIBLE’ 1119 indicates a person responsible for executing the respective phases.

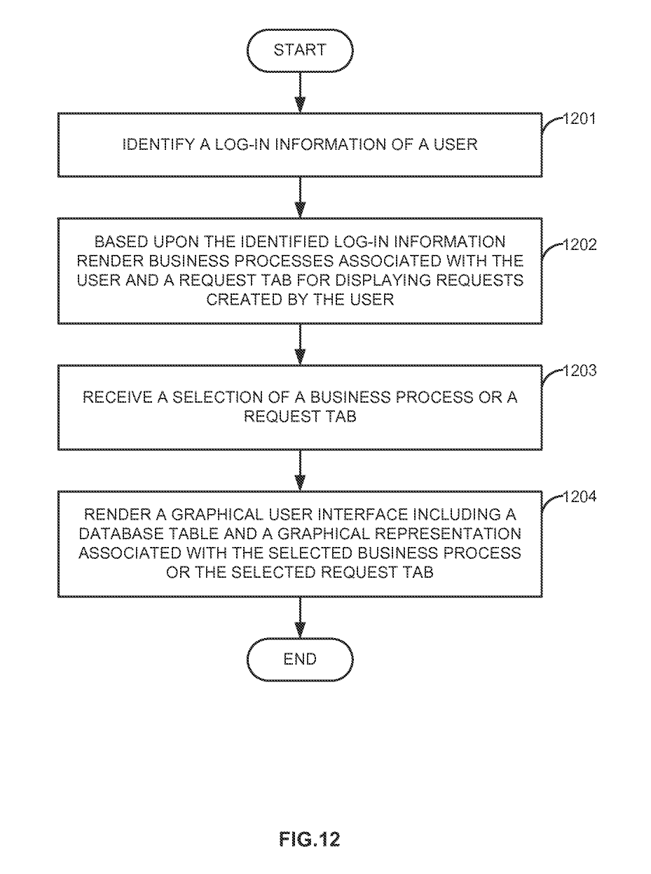

FIG. 12 is a flowchart illustrating a method for rendering the GUI for tracking the business processes BP1-BPN and instances I1-IN associated with the user 120, according to an embodiment. The user 120 logs in the analyzer 110. The analyzer 110 identifies the log-in information of the user 120 at step 1201. Based upon the identified log-in information, the analyzer 110 renders the request tab 140 and the business processes BP1-BPN associated with the user 120 at step 1202. In one embodiment, the analyzer 110 determines whether the user 120 is the requestor, the operator, or both. When the user 120 is the operator, the analyzer 110 displays the business processes BP1-BPN including the requests to be operated by the user 120. When the user 120 is the requestor, the analyzer 110 displays the request tab 140 including the requests created by the user 120. When the user 120 is the requestor as well as the operator, the analyzer 110 displays the business processes BP1-BPN as well as the request tab 140. The request tab 140 is used to display the requests created by the user 120. The user 120 can select any one of the business processes BP1-BPN to operate on the requests created by the other users or the request tab 140 to view the requests created by the user 120. The user 120 selects the request tab 140 or the business process from the rendered business processes BP1-BPN at step 1203. At step 1204, the GUI including the database table and the graphical representation of the selected business process or the request tab 140 is rendered.

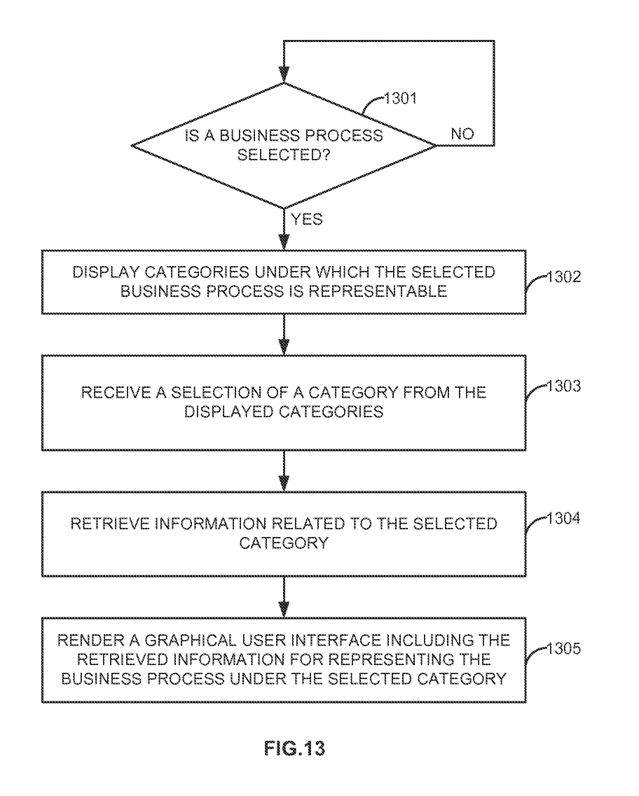

FIG. 13 is a flowchart illustrating a method for representing the selected business process under various categories, according to an embodiment. The analyzer 110 determines whether the user 120 selected any business process from the business processes BP1-BPN including the requests created by other users at step 1301. In case the user selected the business process (step 1301: YES), the analyzer 110 displays the categories, e.g., ‘OVERVIEW’ 440, ‘PHASE VIEW’ 450, and ‘PERFORMANCE VIEW’ 460 under which the selected business process is representable at step 1302. A selection of a category from the displayed categories ‘OVERVIEW’ 440, ‘PHASE VIEW’ 450, and ‘PERFORMANCE VIEW’ 460 is received at step 1303. Information related to the selected category is retrieved at step 1304. At step 1305, the analyzer 110 displays the information related to the selected category on the GUI.

Embodiments described above provide a system and method for analyzing and tracking business processes and instances. Critical information related to business processes and instances are displayed graphically which can be easily and quickly analyzed. The critical information are graphically displayed on a single screen, therefore, the users do not need to navigate across several user interfaces. A database table including information related to business processes or instances is also displayed along with the graphical display. Other non-critical information can be analyzed, e.g., in the database table. The database table is automatically filtered based upon selection in the graphical display. Therefore, users do not need to manually scan database tables to analyze data to make decisions.

In one embodiment, graphical display of business processes is provided under various categories, e.g., an ‘overview,’ a ‘phase view’ and a ‘performance view.’ Under ‘overview’ basic information related to a business process such as various statuses related to the business process, number of requests pending under respective statuses, various phases of the business process, number of requests pending in respective phases along with their statuses, a target time for completing the business process, and an actual cycle time of the business process, etc., are displayed graphically and can be analyzed quickly. Under ‘phase view’ critical information related to respective phases of the business process are displayed graphically. Under ‘performance view’ various indicators and measures are displayed for quickly evaluating performance of the business process or performance of respective phases within the business process. In one embodiment, the performance of the business process or a phase is evaluated for selected time period, e.g., selected calendar week.

In one embodiment, graphical display of an instance or a request includes information such as percentage of the instance executed, target time for completing the instance, time elapsed, and time remaining for completing the instance, etc., which can be quickly analyzed. Forecasted information such as date by which the instance is expected to be completed and whether the instance is expected to be completed on time or would overdue is also displayed. The forecasted information helps users to analyze current situation and take necessary action. Phases associated with the instance are displayed as interactive graphical element. The interactive graphical element includes an indicator to show whether the phase is already completed, completed on time, not completed on time, currently executing, or not yet started. In one embodiment, the interactive graphical element of currently executing phase is highlighted. Therefore, the instance can be minutely analyzed on various phase levels. A database table including information related to respective phases of the instance is also displayed.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape: optical media such as CD-ROMs, DVDs and holographic indicator devices: magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

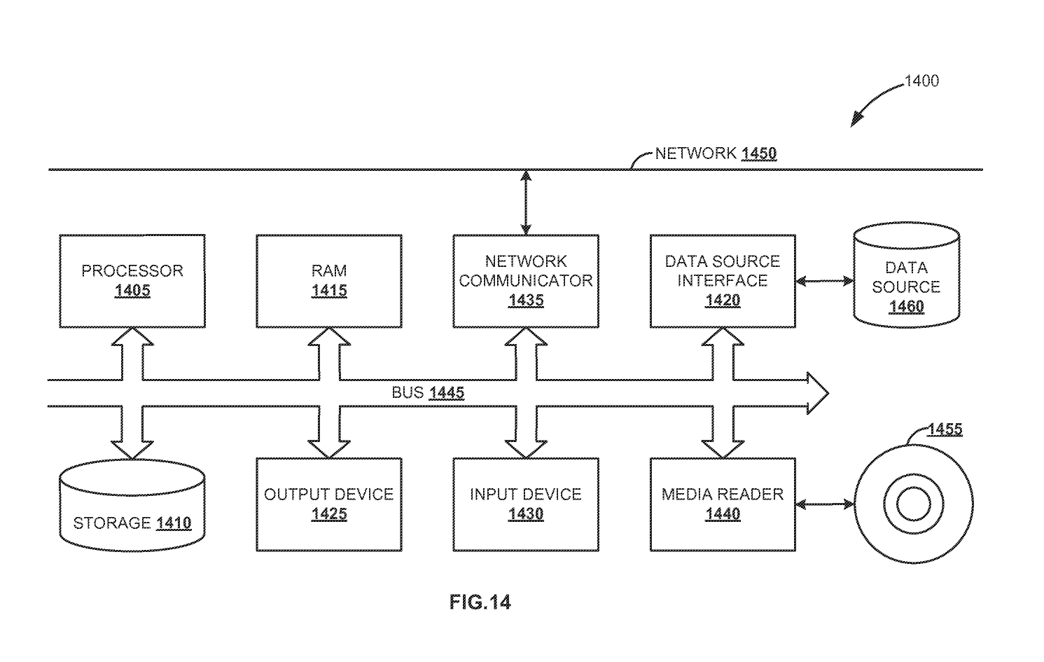

FIG. 14 is a block diagram of an exemplary computer system 1400. The computer system 1400 includes a processor 1405 that executes software instructions or code stored on a computer readable storage medium 1455 to perform the above-illustrated methods. The processor 1405 can include a plurality of cores. The computer system 1400 includes a media reader 1440 to read the instructions from the computer readable storage medium 1455 and store the instructions in storage 1410 or in random access memory (RAM) 1415. The storage 1410 provides a large space for keeping static data where at least some instructions could be stored for later execution. According to some embodiments, such as some in-memory computing system embodiments, the RAM 1415 can have sufficient storage capacity to store much of the data required for processing in the RAM 1415 instead of in the storage 1410. In some embodiments, all of the data required for processing may be stored in the RAM 1415. The stored instructions may be further compiled to generate other representations of the instructions and dynamically stored in the RAM 1415. The processor 1405 reads instructions from the RAM 1415 and performs actions as instructed. According to one embodiment, the computer system 1400 further includes an output device 1425 (e.g., a display) to provide at least some of the results of the execution as output including, but not limited to, visual information to users and an input device 1430 to provide a user or another device with means for entering data and/or otherwise interact with the computer system 1400. Each of these output devices 1425 and input devices 1430 could be joined by one or more additional peripherals to further expand the capabilities of the computer system 1400. A network communicator 1435 may be provided to connect the computer system 1400 to a network 1450 and in turn to other devices connected to the network 1450 including other clients, servers, data stores, and interfaces, for instance. The modules of the computer system 1400 are interconnected via a bus 1445. Computer system 1400 includes a data source interface 1420 to access data source 1460. The data source 1460 can be accessed via one or more abstraction layers implemented in hardware or software. For example, the data source 1460 may be accessed by network 1450. In some embodiments the data source 1460 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g. text files, screen scrapings), hierarchical data (e.g., data in a file system, XML data), files, a plurality of reports, and any other data source accessible through an established protocol, such as, Open Database Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

What is claimed is:

1. An article of manufacture including a non-transitory computer readable storage medium to tangibly store instructions, which when executed cause one or more computers in a network of computers to:
identify a log-in information of a user;
based upon the log-in information, render one or more business processes associated with the user and a request tab for displaying one or more requests created by the user;
receive a selection of one of a business process and the request tab; and
based upon the selection, render:
a database table associated with one of the selected business process and the request tab; and
a graphical representation comprising status indicators displaying respective statuses and a number of requests pending under respective statuses for one of the selected business process and the request tab.

2. The article of manufacture of claim 1, wherein the statuses comprise ‘on track,’ ‘overdue,’ and ‘at risk.’

3. The article of manufacture of claim 1, wherein the status indicators are selectable and when a status indicator is selected, the database table is filtered to display information related to the requests pending under the selected status indicator.

4. The article of manufacture of claim 1 further comprising instructions which when executed cause the one or more computers in the network of computers to:
display categories under which the selected business process is representable;
receive a selection of a category from the displayed categories;
retrieve information of the business process related to the selected category; and
render a GUI including the retrieved information.

5. The article of manufacture of claim 4, wherein the categories comprise an ‘overview,’ a ‘phase view,’ and a ‘performance view.’

6. The article of manufacture of claim 5, wherein when the phase view is selected the one or more computers in the network of computers perform:
determine phases associated with the business process; and
render the GUI comprising:
interactive graphical elements representing respective phases; and
phase status indicators within an interactive graphical element to display statuses and a number of requests pending under respective statuses for a corresponding phase.

7. The article of manufacture of claim 5, wherein when the overview is selected the one or more computers in the network of computers render the GUI comprising:
the status indicators displaying respective statuses and the number of requests pending under respective statuses for the selected business process;
interactive graphical elements representing respective phases of the selected business process, wherein an interactive graphical element includes phase status indicators displaying statuses and a number of requests pending under respective statuses for a corresponding phase; and
a current cycle time and a target cycle time of the business process.

8. The article of manufacture of claim 5, wherein when the performance view is selected the one or more computers in the network of computers render a graphical representation comprising:
a phase graph displaying phases of the selected business process against a cycle time;
a performance graph displaying number of requests of the selected business process completed against a time period; and
performance data of the selected business process including a percentage of requests of the business process completed on time, a number of requests not completed on time, a cycle time of the business process, a target cycle time for completing the business process, and a deviation from the target cycle time.

9. The article of manufacture of claim 1, wherein when a request is selected from the database table, the one or more computers in the network of computers render a GUI comprising:
a database table displaying information related to phases of the selected request; and
a graphical representation of the selected request, the graphical representation comprising:
interactive graphical elements representing respective phases, wherein the interactive graphical element of a currently executing phase is highlighted and wherein the interactive graphical elements include an execution indicator displaying an execution status of respective phases;
an overview information related to the selected request including a percentage of execution of the selected request completed, a target time for completing the selected request, time elapsed since the selected request is created, and time remaining for completing the selected request; and
a forecasted information related to the selected request including a date by which the selected request is expected to be completed and whether the selected request is expected to be completed on time or is expected to overdue.

10. A computer-implemented method for tracking business processes and instances, the method comprising:
identifying a log-in information of a user;
based upon the log-in information, rendering:
one or more business processes associated with the user; and
a request tab for displaying one or more requests created by the user;
receiving a selection of one of a business process and the request tab; and
based upon the selection, rendering:
a database table associated with one of the selected business process and the request tab; and
a graphical representation comprising status indicators displaying respective statuses and a number of requests pending under respective statuses for one of the selected business process and the request tab.

11. The method of claim 10, wherein upon receiving the selection of the business process, performing at least one of:
displaying categories under which the selected business process is representable, wherein the categories comprise an ‘overview,’ a ‘phase view,’ and a ‘performance view;’
receiving a selection of a category from the displayed categories;
retrieving information related to the selected category; and
rendering a GUI including the retrieved information.

12. The method of claim 11 further comprising:
upon receiving the selection of the phase view, determining phases associated with the business process; and
rendering the GUI comprising:
interactive graphical elements representing respective phases; and
phase status indicators within an interactive graphical element to display statuses and a number of requests pending under respective statuses for a corresponding phase.

13. The method of claim 11 further comprising:
upon receiving the selection of the overview, determining a current cycle time and a target cycle time of the business process; and
rendering the GUI comprising:
the status indicators displaying respective statuses and the number of requests pending under respective statuses for the selected business process;
interactive graphical elements representing respective phases of the selected business process, wherein an interactive graphical element includes phase status indicators displaying statuses and a number of requests pending under respective statuses for a corresponding phase; and
the current cycle time and the target cycle time of the business process.

14. The method of claim 11 further comprising:
upon receiving the selection of the performance view, rendering the GUI comprising:
a phase graph displaying phases of the selected business process against a cycle time;
a performance graph displaying number of requests of the selected business process completed against a time period; and
performance data of the selected business process including a percentage of requests of the business process completed on time, a number of requests not completed on time, a cycle time of the business process, a target cycle time for completing the business process, and a deviation from the target cycle time.

15. A computer system for tracking business processes and instances, the system comprising:
a memory to store program code; and
a processor communicatively coupled to the memory, the processor configured to execute the program code to:
identify a log-in information of a user;
based upon the log-in information, render:
one or more business processes associated with the user; and
a request tab for displaying one or more requests created by the user;
receive a selection of one of a business process and the request tab; and
based upon the selection, render a GUI comprising:
a database table associated with one of the selected business process and the request tab; and
a graphical representation including status indicators displaying respective statuses and a number of requests pending under respective statuses for one of the selected business process and the request tab.

16. The computer system of claim 15, wherein the GUI further comprises category tabs including an ‘overview’ tab, a ‘phase view’ tab, and a ‘performance view’ tab for representing the selected business process under one or more categories.

17. The computer system of claim 16, wherein when the ‘phase view’ tab is selected, a GUI is generated comprising:
interactive graphical elements representing respective phases of the business process; and
phase status indicators within an interactive graphical element to display statuses and a number of requests pending under respective statuses for a corresponding phase.

18. The computer system of claim 16, wherein when the ‘performance view’ tab is selected, a graphical representation is generated comprising:
a phase graph displaying phases of the selected business process against a cycle time;
a performance graph displaying number of requests of the selected business process completed against a time period; and
performance data of the selected business process including a percentage of requests of the business process completed on time, number of requests not completed on time, a cycle time of the business process, a target cycle time for completing the business process, and a deviation from the target cycle time.

19. The computer system of claim 16, wherein when the ‘overview’ tab is selected, a GUI is generated comprising:
the status indicators displaying respective statuses and the number of requests pending under respective statuses for the selected business process;
interactive graphical elements representing respective phases of the business process;
phase status indicators within respective interactive graphical element displaying statuses and a number of requests pending under respective statuses for a corresponding phase; and
a current cycle time and a target cycle time of the business process.

20. The computer system of claim 15, wherein the processor is further configured to execute the program code to:
receive a selection of a request from the database table; and
based upon the selected request, generate a GUI comprising:
a database table displaying information related to phases of the selected request; and
a graphical representation of the selected request, the graphical representation comprising:
interactive graphical elements representing respective phases of the selected request, wherein the interactive graphical elements include an execution indicator to display an execution status of respective phases;
an overview information of the selected request including a percentage of execution of the selected request completed, a target time for completing the selected request, time elapsed since the selected request is created, and time remaining for completing the selected request; and
a forecasted information related to the selected request including a date by which the selected request is expected to be completed and whether the selected request is expected to be completed on time or is expected to overdue.
